(19) United States
(12) Patent Application Publication
(10) Pub. No.: US 2026/0091412 A1
(43) Pub. Date: Apr. 2, 2026

(54) A SORTING MACHINE WITH A DYNAMIC VISION SYSTEM

(71) Applicant: Seyed Ali MOAZEN, Tehran (IR)

(72) Inventors: Seyed Ali MOAZEN, Tehran (IR); Hajar ZAREYI SE DEHI ZADEH, Tehran (IR)

(21) Appl. No.: 19/110,833

(22) PCT Filed: Sep. 12, 2022
(86) PCT No.: PCT/IB2022/058554

§ 371 Date: Mar. 12, 2025

(51) Int. Cl. B07C 5/342; B07C 5/36

(52) U.S. Cl. CPC B07C 5/3422; B07C 5/361

(57) ABSTRACT

A sorting machine with a dynamic vision system is developed to provide dynamic lighting, imaging, and analysis of industrial materials while moving the conveyor. The sorting machine comprises a washing box, a vision system, a control unit, and a transferring unit. The vision system comprises dynamic imaging unit and dynamic lighting unit. The vision system is configured to provide a dynamic lighting and a dynamic imaging of industrial materials. The imaging unit comprises a camera, a camera movement unit, and a dynamic camera stand. The lighting unit comprises an optical section, a linear motion adjuster section, and a light angle adjuster section.

### TECHNICAL FIELD

The present disclosure is related to the field of industrial devices and construction, and in particular, related to a sorting machine with a dynamic vision system to provide dynamic lighting, imaging, and analysis of industrial materials while moving the conveyor.

### BACKGROUND ART

Sorting moving parts and equipment is one of the basic needs in industries. Separation of objects is done based on appearance characteristics such as dimensions, weight, shape, color, or based on chemical analysis. One of the topics related to the classification of materials in the industry is the use of industrial cameras and related analyzes, in order to check the apparent quality and classify or separate parts according to available data. One of the applications of this method, especially in the stone industry and color recognition, is the degree of brightness and its veins and roots. To determine the color, degree of brightness, and veins and roots of building stones, using a sorting machine and classifying stones is a common method.

There are some problems and challenges in using sorting machines to sort industrial materials. One of the problems of sorting machines is related to the optics and lighting settings of the processing unit of the industrial materials, especially the stone materials. Therefore, creating a suitable light space for mechanized detection of stone color and its veins is very important. Also, proper orientation and distribution of light to eliminate excess light and uniformity and lack of shadow formation at the edges is one of the challenges. Other challenges include adjusting the location of the camera at the focal point to create a proper and accurate image of the industrial material according to its various dimensions and creating the right angle of light to prevent the creation of additional shadows and colors.

Thus, to overcome the above-mentioned issues, a cost-effective and integrated sorting machine with a dynamic vision system has been introduced to provide dynamic lighting, imaging, and analysis of industrial materials while moving the conveyor.

### SUMMARY OF INVENTION

This summary is intended to provide an overview of the subject matter of this disclosure, and is not intended to identify essential elements or key elements of the subject matter, nor is it intended to be used to determine the scope of the claimed implementations. The proper scope of this disclosure may be ascertained from the claims set forth below in view of the detailed description below and the drawings.

In one general aspect, the present disclosure describes an exemplary sorting machine for adjusting a light and camera to create a proper image of industrial parts. An exemplary machine may comprise a dynamic vision system, wherein the dynamic vision system may comprise a lightbox, that the lightbox may be configured to provide dynamic lighting and imaging and perform an accurate industrial part sorting.

The above general aspect may have one or more of the following features. In an exemplary implementation, the exemplary machine may further comprise a first unit that may be configured to prepare industrial parts for processing. In an exemplary implementation, the exemplary machine may comprise a control unit that may be configured to control a sorting machine's performance and perform an analysis on industrial materials. In an exemplary implementation, the exemplary machine may comprise a second unit, wherein the second unit may be configured to transfer industrial parts in the sorting machine. In an exemplary implementation, the sorting machine further may comprise a third unit that may be configured to print information on industrial parts. In an exemplary implementation, the lightbox may comprise an imaging unit and a lighting unit. In an exemplary implementation, the imaging unit may comprise a camera, a camera movement unit, and a dynamic camera stand. In an exemplary implementation, the dynamic camera stand may be configured to enable the camera to change an angle and movement in a longitudinal, transverse, and vertical directions. In an exemplary implementation, the dynamic camera stand may comprise a rotational position adjuster section, an angle adjuster section, and a longitudinal distance adjuster section. In an exemplary implementation, the lighting unit may comprise an optical section, a linear motion adjuster section, and a light angle adjuster section.

In another general aspect, the present disclosure is directed to a sorting machine for adjusting a light and camera to create a proper image of industrial parts. An exemplary machine may comprise a lightbox, wherein the lightbox may comprise a lighting unit and an imaging unit, that the lighting unit may comprise an optical section, a linear motion adjuster section, and a light angle adjuster section, and the imaging unit may comprise a camera, a camera movement unit, and a dynamic camera stand.

The above general aspect may have one or more of the following features. In an exemplary implementation, the exemplary machine may further comprise a washing box, wherein the washing box may be configured to prepare industrial parts for processing. In an exemplary implementation, the exemplary machine may comprise a control unit that may be configured to control a sorting machine's performance and perform an analysis on industrial materials. In an exemplary implementation, the exemplary machine may further comprise a transferring unit, wherein the transferring unit may be configured to transfer industrial parts in the sorting machine. In an exemplary implementation, the exemplary machine may comprise a printing unit, wherein the printing unit may comprise a printer and a sensor unit. In an exemplary implementation, the exemplary machine may further comprise an application, wherein the application may be configured to report industrial parts information, manage product production, and manage industrial parts sorting. In an exemplary implementation, the dynamic camera stand may comprise a rotational position adjuster section, an angle adjuster section, and a longitudinal distance adjuster section. In an exemplary implementation, the optical section may comprise one or more flat optical plates, wherein the flat optical plates may be configured to create a uniform lighting. In an exemplary implementation, the linear motion adjuster section may be configured to adjust the distance changes in the longitudinal and transverse directions. In an exemplary implementation, the light angle adjuster section may be configured to adjust a rotation angle of the optical section. In an exemplary implementation, the camera movement unit may comprise at least one electric motor. In an exemplary implementation, the rotational position adjuster section may comprise a rotating plate, the rotating plate is configured to perform a 360-degree horizontal imaging utilizing the camera movement unit. In an exemplary implementation, the light angle adjuster section may comprise a camera arm, wherein the camera arm may be configured to enable the camera to perform 180 degrees of vertical rotation utilizing the camera movement unit. In an exemplary implementation, the longitudinal distance adjuster section may comprise at least five steps, wherein the steps may be configured to enable the camera to be positioned in different places of the dynamic camera stand to create an optimal image. In an exemplary implementation, the lightbox and the control unit may comprise an independent frame base to reduce vibrations. In an exemplary implementation, a cooling unit may be installed next to the control unit to prevent an excess heat production.

### BRIEF DESCRIPTION OF DRAWINGS

The drawing figures depict one or more implementations in accordance with the present teachings, by way of example only, not by way of limitation. In the figures, like reference numerals refer to the same or similar elements.

FIG. 1 illustrates an exemplary configuration diagram of a sorting machine with a dynamic lightbox system, consistent with one or more exemplary embodiments of the present disclosure.

FIG. 2 illustrates an exemplary block diagram of a vision system, consistent with one or more exemplary embodiments of the present disclosure.

FIG. 3 illustrates an exemplary block diagram of an imaging unit, consistent with one or more exemplary embodiments of the present disclosure.

FIG. 4 illustrates an exemplary block diagram of a dynamic camera stand, consistent with one or more exemplary embodiments of the present disclosure.

FIG. 5 illustrates an exemplary block diagram of a lighting unit, consistent with one or more exemplary embodiments of the present disclosure.

FIG. 6 illustrates an exemplary schematic side view of a vision system, consistent with one or more exemplary embodiments of the present disclosure.

FIG. 7 illustrates an exemplary configuration diagram of a lighting unit, consistent with one or more exemplary embodiments of the present disclosure.

FIG. 8 illustrates an exemplary configuration diagram of an imaging unit, consistent with one or more exemplary embodiments of the present disclosure.

### DESCRIPTION OF EMBODIMENTS

In the following detailed description, numerous specific details are set forth by way of examples in order to provide a thorough understanding of the relevant teachings. However, it should be apparent that the present teachings may be practiced without such details. In other instances, well-known methods, components, and/or elements have been described at a relatively high-level, without detail, in order to avoid unnecessarily obscuring aspects of the present teachings. The following detailed description is, therefore, not to be taken in a limiting sense, and the scope of the present disclosure is defined only by the appended claims.

The following detailed description is presented to enable a person skilled in the art to make and use the methods and apparatuses disclosed in exemplary embodiments of the present disclosure. For purposes of explanation, specific nomenclature is set forth provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

In an exemplary embodiment, an exemplary sorting machine with a dynamic lightbox system may be developed to provide dynamic lighting, imaging, and analysis of industrial materials. For example, industrial materials may include stones, ceramics, tiles, or flat pieces.

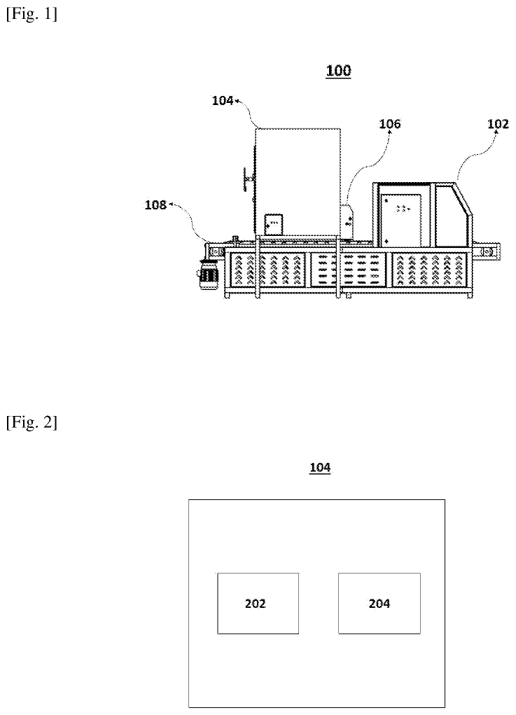

FIG. 1 illustrates an exemplary configuration diagram of a sorting machine with a dynamic lightbox system, consistent with one or more exemplary embodiments of the present disclosure. In an exemplary embodiment, as illustrated in FIG. 1, the exemplary machine (100) may comprise a first input unit (102), a vision system (104), a control unit (106), and a transferring unit (108). In an exemplary embodiment, the exemplary machine (100) may be configured to check one or more apparent quality features and classify a plurality of industrial materials. In an exemplary embodiment, apparent quality features may comprise a material's color, a degree of brightness, a material's veins and root, or other apparent quality features that are well known for those skilled in the art. In an exemplary embodiment, the industrial materials may enter the first input unit (102) such that the first input unit (102) may be configured to prepare industrial parts for processing. In an exemplary embodiment, the first input unit (102) may comprise a washing box that may comprise a water transfer unit, a brushing unit, and an air transfer unit. In an exemplary embodiment, the water transfer unit may comprise one or more water nozzles. In an exemplary embodiment, the air transfer unit may comprise one or more air blowers. In an exemplary embodiment, the vision system (104) may be configured to provide a dynamic lighting and a dynamic imaging of industrial materials. In an exemplary embodiment, the vision system (104) may comprise a dynamic lightbox system. In an exemplary embodiment, the control unit (106) may be configured to control the exemplary machine (100) and perform an analysis of industrial material properties.

In an exemplary embodiment, the control unit (106) may comprise a processing unit, a storage unit, a communication unit, and an application. The processing unit may comprise one or more processor devices. In an exemplary embodiment, a processor device may be an application-specific processor device or a general-purpose processor device. In an exemplary embodiment, a processor device may comprise a micro-controller, a microprocessor, an embedded processor, a DSP processor, a media processor, or other types of processor devices that are well known for those skilled in the art.

In an exemplary embodiment, the storage unit may comprise one or more memories. In an exemplary embodiment, the storage unit may be configured to store processor-readable instructions, the application, and sorting machine information. For example, the sorting machine information may include industrial material properties. In an exemplary embodiment, the communication unit may be configured to establish a connection between the first input unit (102), the vision system (104), the control unit (106), and the transferring unit (108). In an exemplary embodiment, the communication unit may comprise an internet of things (IoT) network, a Wi-Fi network, a cellular network, for example, but not limited to, 3G, 4G, an ethernet network, a Bluetooth network, or other communication networks that are well known for those skilled in the art.

In an exemplary embodiment, the control unit (106) may further comprise a cooling unit such that the cooling unit may be configured to prevent production of excess heat in the control unit (106). The cooling unit may comprise one or more ventilators.

In an exemplary embodiment, the exemplary machine (100) may further comprise a printing unit so that may be configured to print one or more industrial material specifications. In an exemplary embodiment, industrial material specifications may comprise an industrial material's color, an industrial material brightness, an industrial material degree and amount of line, an industrial material pattern, an industrial material identity document (ID), or other industrial material specifications that are well known for those skilled in the art. In an exemplary embodiment, the printing unit may comprise a printer device and a sensor unit.

In an exemplary embodiment, the application may be configured to report industrial material information, manage product production, and manage industrial parts sorting. In an exemplary embodiment, the application may comprise an artificial intelligence unit and a database unit.

FIG. 2 illustrates an exemplary block diagram of the vision system (104), consistent with one or more exemplary embodiments of the present disclosure. In an exemplary embodiment, the vision system (104) may comprise an imaging unit (202) and a lighting unit (204).

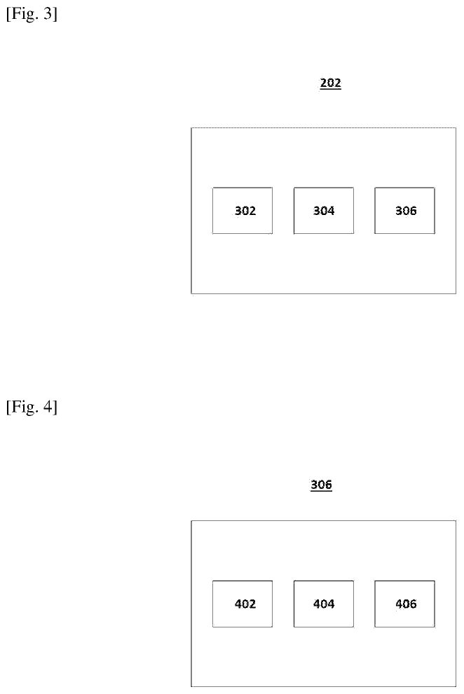

FIG. 3 illustrates an exemplary block diagram of the imaging unit (202), consistent with one or more exemplary embodiments of the present disclosure. In an exemplary embodiment, the imaging unit may comprise a camera (302), a camera movement unit (304), and a dynamic camera stand (306). In an exemplary embodiment, the camera movement unit (304) and the dynamic camera stand (306) may be configured to enable the camera (302) to change an angle and movement. In an exemplary embodiment, the camera (302) may be capable of moving in longitudinal, transverse, and vertical directions. In an exemplary embodiment, the camera movement unit (304) may comprise at least one electric motor. In an exemplary embodiment, the camera movement unit (304) may comprise a first electric motor and a second electric motor.

FIG. 4 illustrates an exemplary block diagram of the dynamic camera stand (306), consistent with one or more exemplary embodiments of the present disclosure. In an exemplary embodiment, the dynamic camera stand (306) may comprise a rotational position adjuster section (402), an angle adjuster section (404), and a longitudinal distance adjuster section (406). In an exemplary embodiment, the rotational position adjuster section (402) may be configured to enable the camera (302) to perform a horizontal rotation. In an exemplary embodiment, the rotational position adjuster section (402) may perform a horizontal rotation utilizing the first electric motor. In an exemplary embodiment, a horizontal rotation may comprise a rotation in a range of 0 to 360 degrees. In an exemplary embodiment, the rotational position adjuster section (402) may comprise a rotating plate. In an exemplary embodiment, the angle adjuster section (404) may be configured to enable the camera (302) to perform a vertical rotation. In an exemplary embodiment, the angle adjuster section (404) may perform a vertical rotation utilizing the second electric motor. In an exemplary embodiment, a vertical rotation may comprise a rotation in a range of 0 to 180 degrees. In an exemplary embodiment, the angle adjuster section (404) may comprise a camera arm. In an exemplary embodiment, the longitudinal distance adjuster section (406) may be configured to enable the camera to be positioned in different places of the dynamic camera stand (306). In an exemplary embodiment, the longitudinal distance adjuster section (406) may comprise at least five steps. In an exemplary embodiment, the steps may be spaced apart and on the rotating plate.

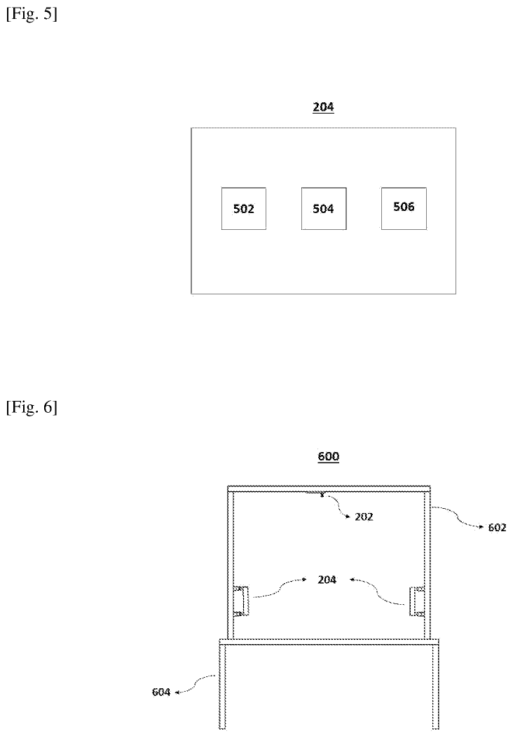

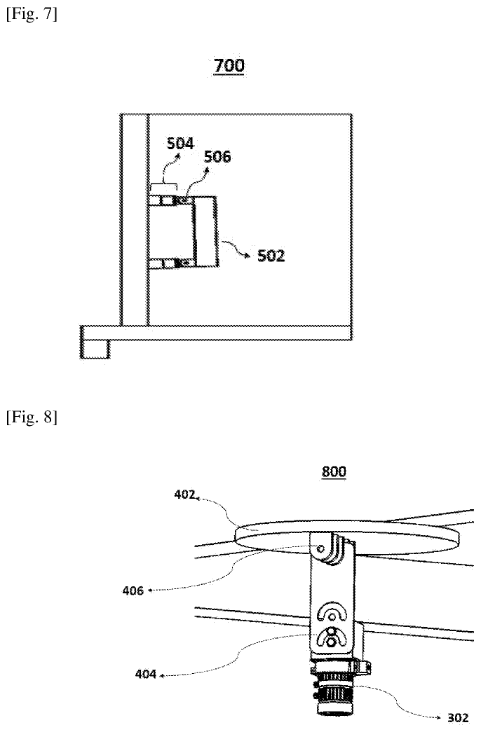

FIG. 5 illustrates an exemplary block diagram of the lighting unit (204), consistent with one or more exemplary embodiments of the present disclosure. In an exemplary embodiment, the lighting unit (204) may comprise an optical section (502), a linear motion adjuster section (504), and a light angle adjuster section (506). In an exemplary embodiment, the lighting unit (204) may be configured to provide a suitable light emission for an accurate imaging. In an exemplary embodiment, a suitable light emission may comprise a plurality of lighting features. For example, the lighting features may comprise an exposure angle, a light source shape, a light source type, an exposure speed, a disturbing light intensity, and a base light color. In an exemplary embodiment, an optical section (502) may comprise a light source. In an exemplary embodiment, the base light color of the light source may comprise a natural sunlight color. In an exemplary embodiment, the light source may comprise a plane light source. In an exemplary embodiment, a plane light source may be configured to provide a uniform lighting. In an exemplary embodiment, the plane light source may comprise at least two optical plates. In an exemplary embodiment, the linear motion adjuster section (504) may be configured to adjust the distance changes of the plane light source in the longitudinal and transverse directions. In an exemplary embodiment, the linear motion adjuster section (504) may comprise a longitudinal adjusting unit and a transverse adjusting unit. In an exemplary embodiment, the longitudinal adjusting unit may comprise a telescopic base. In an exemplary embodiment, the telescopic base may be able to increase or decrease in length. In an exemplary embodiment, the telescopic base may have one or more sections. In an exemplary embodiment, the sections may be interlocked. In an exemplary embodiment, the light angle adjuster section (506) may be configured to adjust a rotation angle of the plane light source. In an exemplary embodiment, a rotation angle may comprise a rotation in a range of 0 to 180 degrees. In an exemplary embodiment, the light angle adjuster section (506) may comprise a bending arm.

FIG. 6 illustrates an exemplary schematic side view of the vision system (104), consistent with one or more exemplary embodiments of the present disclosure. In an exemplary embodiment, the vision system (104) may comprise a frame (602), the imaging unit (202), the lighting unit (204), and a frame base (604). In an exemplary embodiment, a frame (602) may comprise a box structure. In an exemplary embodiment, the lighting unit (204) and the imaging unit may be embedded inside the frame (602). In an exemplary embodiment, the imaging unit (202) may be mounted on a frame roof. In an exemplary embodiment, the lighting unit (204) may be mounted on side walls of the frame. In an exemplary embodiment, the frame base (604) may be installed independently of the transferring unit (108) under the frame (602). In an exemplary embodiment, the frame base (604) may be designed to reduce the impact on the vision system (104) due to the mobility of industrial materials and the transferring unit (108). In an exemplary embodiment, the frame base (604) may comprise at least four frame legs.

Furthermore, it is to be understood that the invention is solely defined by the appended claims. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “at least one” and indefinite articles such as “a” or “an” (e.g., “a” and/or “an” should typically be interpreted to mean “at least one” or “one or more” or “a plurality of”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood that the terms and expressions used herein have the ordinary meaning as is accorded to such terms and expressions with respect to their corresponding respective areas of inquiry and study except where specific meanings have otherwise been set forth herein. Relational terms such as first, second, and third and the like may be used solely to distinguish one entity or action from another without necessarily requiring or implying any actual such relationship or order between such entities or actions. The terms “comprises,” “include,” “comprising,” or any other variation thereof, are intended to cover a non-exclusive inclusion, such that a process, method, article, apparatus, or device that comprises a list of elements does not include only those elements but may include other elements not expressly listed or inherent to such process, method, article, apparatus, or device. An element proceeded by “a” or “an” does not, without further constraints, preclude the existence of additional identical elements in the process, method, article, or device that comprises the element.

Moreover, “may” and other permissive terms are used herein for describing optional features of various embodiments. These terms likewise describe selectable or configurable features generally, unless the context dictates.

1. A sorting machine for adjusting a light and camera to create a proper image of industrial parts, comprising:
a dynamic vision system comprising a lightbox, wherein the lightbox is configured to provide dynamic lighting and imaging and perform an accurate industrial part sorting.

2. The sorting machine according to claim 1, further comprising:
a first unit configured to prepare industrial parts for processing;
a control unit configured to control a sorting machine's performance and perform an analysis on industrial materials;
a second unit configured to transfer industrial parts in the sorting machine, and
a third unit configured to print information on industrial parts.

3. The sorting machine according to claim 1, wherein the lightbox comprises an imaging unit and a lighting unit.

4. The sorting machine according to claim 3, wherein the imaging unit comprises a camera, a camera movement unit, and a dynamic camera stand.

5. The sorting machine according to claim 4, wherein the dynamic camera stand is configured to enable the camera to change an angle and movement in a longitudinal, transverse, and vertical directions.

6. The sorting machine according to claim 4, wherein the dynamic camera stand comprises a rotational position adjuster section, an angle adjuster section, and a longitudinal distance adjuster section.

7. The sorting machine according to claim 3, wherein the lighting unit comprises an optical section, a linear motion adjuster section, and a light angle adjuster section.

8. A sorting machine for adjusting a light and camera to create a proper image of industrial parts, comprising:
a dynamic lightbox system comprising a lighting unit and an imaging unit, wherein the lighting unit comprises an optical section, a linear motion adjuster section, and a light angle adjuster section, and the imaging unit comprises a camera, a camera movement unit, and a dynamic camera stand.

9. The sorting machine according to claim 8, further comprising:
a washing box, wherein the washing box is configured to prepare industrial parts for processing;
a control unit configured to control a sorting machine's performance and perform an analysis on industrial materials;
a transferring unit configured to transfer industrial parts in the sorting machine, and
a printing unit comprising a printer and a sensor unit.

10. The sorting machine according to claim 8, further comprising an application wherein the application is configured to report industrial parts information, manage product production, and manage industrial parts sorting.

11. The sorting machine according to claim 8, wherein the dynamic camera stand comprises a rotational position adjuster section, an angle adjuster section, and a longitudinal distance adjuster section.

12. The sorting machine according to claim 8, wherein the optical section comprises one or more flat optical plates, the flat optical plates are configured to create a uniform lighting.

13. The sorting machine according to claim 8, wherein the linear motion adjuster section is configured to adjust the distance changes in the longitudinal and transverse directions.

14. The sorting machine according to claim 8, wherein the light angle adjuster section is configured to adjust a rotation angle of the optical section.

15. The sorting machine according to claim 8, wherein the camera movement unit comprises at least one electric motor.

16. The sorting machine according to claim 8, wherein the rotational position adjuster section comprises a rotating plate, the rotating plate is configured to perform a 360-degree horizontal imaging utilizing the camera movement unit.

17. The sorting machine according to claim 8, wherein the light angle adjuster section comprises a camera arm, the camera arm is configured to enable the camera to perform 180 degrees of vertical rotation utilizing the camera movement unit.

18. The sorting machine according to claim 8, wherein the longitudinal distance adjuster section comprises at least five steps, the steps are configured to enable the camera to be positioned in different places of the dynamic camera stand to create an optimal image.

19. The sorting machine according to claims 8 and 9, wherein the lightbox and the control unit comprise an independent frame base to reduce vibrations.

20. The sorting machine according to claim 8, wherein a cooling unit is installed next to the control unit to prevent an excess heat production.
